(19) United States
(12) Patent Application Publication
(10) Pub. No.: US 2009/0199906 A1
(43) Pub. Date: Aug. 13, 2009

(54) RECIRCULATING FILLING VALVE ASSEMBLY

(75) Inventor: Michael J. Brown, Baltimore, MD (US)

Correspondence Address: HOWARD & HOWARD ATTORNEYS PLLC, 450 West Fourth Street, Royal Oak, MI, 48067, US

(73) Assignee: ADCOR INDUSTRIES, INC., Baltimore, MD (US)

(21) Appl. No.: 12/367,123

(22) Filed: Feb. 6, 2009

Related U.S. Application Data
(60) Provisional application No. 61/065,031, filed on Feb. 8, 2008.

(51) Int. Cl. F16K 17/00

(52) U.S. Cl. 137/115.01

(57) ABSTRACT

A filling valve assembly including a support adapted for being operably fixed to a filling machine and through which a liquid is conveyed from the filling machine. The filling valve assembly includes a valve subassembly interchangeably attached to the support, the valve subassembly and support having integrated fluid passages in fluid communication when the valve subassembly is attached to the support. At least a portion of the liquid received by the support from the filling machine is conveyed to the valve subassembly, and at least a portion of the liquid received by the valve subassembly from the support is selectively dispensed from the valve subassembly. The fluid passages of the support and the valve subassembly are connected through fluid openings located in respective interfacing surfaces of the valve subassembly and the support, when the valve subassembly is attached to the support. The filling valve assembly may be a recirculating filling valve assembly.

### CROSS REFERENCE TO RELATED APPLICATIONS FROM WHICH PRIORITY IS CLAIMED

This application claims priority to U.S. Provisional Application Ser. No. 61/065,031, filed on Feb. 8, 2008 (Attorney Docket No. 065111.00122), which is hereby incorporated by reference in its entirety.

### BACKGROUND OF THE INVENTION

1. Field of the Invention

The subject invention relates to a beverage filling valve capable of recirculating fluid.

2. Description of the Prior Art

Filling valve apparatuses for beverage filling machines are known in the art for injecting liquids into beverage containers. Generally, a filling valve apparatus is used with a beverage filling machine (not shown). Beverage filling machines are known in the art for injecting a fluid into a container (not shown), such as injecting a beverage into a bottle or can. The beverage filling machine often uses many filling valve apparatuses for filling many containers simultaneously. Typically, a conveyor (not shown) is used to bring the container to the filling valve apparatus. The filling valve apparatus then descends over the container and fills the container with the beverage. Once filled, the filling valve apparatus lifts up and the conveyor moves the container away from the filling valve apparatus.

However, as the filling valve apparatus is used, certain parts of the filling valve apparatus may begin to wear. For instance, the liquid being injected into the beverage container with the filling valve apparatus may corrode certain parts of the filling valve apparatus. Once corroded, those parts of the filling valve apparatus must be replaced before the beverage filling machine may continue operating. Replacing the corroded parts of the filling valve apparatus can be difficult and time consuming since this often requires removing and replacing the entire filling valve apparatus, which takes considerable time. Also, the beverage filling machine typically incorporates many filling valve apparatuses, and replacing one filling valve apparatus requires stopping the entire beverage filling machine. When filling large quantities of bottles each day, stopping the beverage filling machine to replace the filling valve apparatus reduces production and results in lost profits.

Therefore, a filling valve apparatus may include at least one release mechanism to quickly replace corroded portions of the filling valve apparatus. Generally, the release mechanism couples an interchangeable valve portion to another portion of the filling valve apparatus, such that the interchangeable valve portion may be selectively removed from the apparatus with the release mechanism to facilitate its repair or replacement.

Recirculating filling valve apparatuses are typically used for filling containers with a liquid that is either hot or cold, and is continually circulated through the valve apparatus and a heat exchanger in fluid communication with the valve apparatus, to continually maintain a desired temperature even when not being dispensed from the valve apparatus and/or injected into the container through the valve apparatus. Recirculating filling valve apparatuses may also be typically used when the liquid may congeal, or cause other concerns if allowed to remain in the filling valve apparatus between injections rather than caused to continually flow through the apparatus.

It is desirable to provide a filling valve apparatus with such a release mechanism, and further, to provide a filling valve apparatus in which the valve subassembly may be interchangeably removed as a module, for quickly replacing a valve subassembly requiring replacement or repair with one in proper condition, and to provide the valve subassembly with improved means for quickly accessing and replacing components.

### SUMMARY OF THE INVENTION

The present invention provides a filling valve assembly including a support adapted for being operably fixed to a filling machine and through which liquid is conveyed from the filling machine. The filling valve assembly includes a valve subassembly interchangeably attached to the support, the valve subassembly and support having integrated fluid passages in fluid communication when the valve subassembly is attached to the support. At least a portion of the liquid received by the support from the filling machine is conveyed to the valve subassembly, and at least a portion of the liquid received by the valve subassembly from the support is selectively dispensed from the valve subassembly. The fluid passages of the support and the valve subassembly are connected through fluid openings located in respective interfacing surfaces of the valve subassembly and the support, when the valve subassembly is attached to the support. The filling valve assembly may be a recirculating valve assembly.

The present invention also provides a filling valve assembly including a support fixed to a filling machine, and a valve subassembly selectively mounted to the support, at least a portion of the liquid received by the valve subassembly from the filling machine being selectively dispensed from the valve subassembly when the valve subassembly is mounted to the support and in fluid communication with the filling machine. The valve subassembly and the support have respectively interengagable features through the engagement of which the valve subassembly is mounted to the support. These respectively interengageable features include a lip provided on one of the valve subassembly and the support, and a notch into which the lip is received when the valve subassembly is mounted to the support provided on the other of the valve subassembly and the support. These respectively interengageable features further include a tab provided on one of the valve subassembly and the support, and a latch provided on the other of the valve subassembly and the support, the tab and latch being selectively engaged when the lip is received in the notch. The valve subassembly is mounted to the support through the engagement of the latch and the tab. The filling valve assembly may be a recirculating valve assembly.

The present invention also provides a filling valve assembly including a valve body having an end and an opening at the valve body end, and an elongate valve stem disposed within the valve body, the valve stem having a first end and an opposite second end and being installed into and removed from the valve body through the valve body opening. The valve stem is longitudinally movable within the valve body along a central axis, the flow of a liquid received in the valve body, from the valve body through the valve body opening, being controlled in response to longitudinal movement of the valve stem. A neck slide is disposed at the valve body end and is laterally movable relative to the central axis. The neck slide has selective locked and first unlocked positions, and the neck slide and valve body have respectively interengaging features through which the neck slide is retained to the valve body in the neck slide locked and unlocked positions. The filling valve assembly also includes a removable exit cone disposed at the valve body end, the exit cone covering the valve body opening, with liquid flow from the valve body through the valve body opening being through the exit cone. The neck slide and the exit cone have respectively interengaging features through which the exit cone is retained to the valve body and the neck slide in the neck slide locked position, and the exit cone is separable from the valve body and neck slide in the neck slide first unlocked position.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a filling valve assembly in accordance with the subject invention;

FIG. 2 is a transparent side view of the filling valve assembly;

FIG. 3 is an exploded side view of the filling valve assembly;

FIG. 4 is another side view of the filling valve assembly;

FIG. 5 is a side view of the filling valve assembly with a valve subassembly detached from a support;

FIG. 6A is a side view of the valve subassembly;

FIG. 6B is a fragmentary perspective view of the valve subassembly;

FIG. 7 is a perspective view of the support with a latch in an unlocked position;

FIG. 8 is a perspective view of the support with the latch in a locked position;

FIG. 9 is a under-side view of the latch in the unlocked position with a tab of a valve body spaced therefrom;

FIG. 10 is an under-side view of the latch in the unlocked position with the tab disposed therein;

FIG. 11 is a bottom view of the latch in the locked position securing the tab of the valve body;

FIG. 12 is a rear perspective view of the filling valve assembly;

FIG. 13 is a rear perspective view of the filling valve assembly with an exit cone detached therefrom;

FIG. 14 is a front perspective view of the filling valve assembly with the exit cone detached therefrom;

FIG. 15 is a front perspective view of the filling valve assembly with the exit cone detached and a valve stem released from the valve body;

FIGS. 16-19 are under-side views of the filling valve assembly illustrating the operation of a neck slide;

FIGS. 20A-20B are various views of a tension plug;

FIGS. 21A-21B are various views of a valve stem tip;

FIG. 22 is a transparent view of an actuator;

FIG. 23 is a transparent view of a recirculation device;

FIG. 24A is a bottom view of the neck slide;

FIG. 24B is a partial cross-sectional view of the neck slide along line 24B-24B of FIG. 24A; and

FIG. 24C is an end view of the neck slide.

While the invention is susceptible to various modifications and alternative forms, specific embodiments thereof are shown by way of example in the drawings and may herein be described in detail. It should be understood, however, that the drawings and detailed description are not intended to limit the invention to the particular form disclosed, but on the contrary, the intention is to cover all modifications, equivalents and alternatives falling within the spirit and scope of the present invention as defined by the appended claims.

Elements shown in more than one Figure that may be similarly configured have been indicated using the same reference numerals.

### DETAILED DESCRIPTION OF THE PREFERRED EMBODIMENT

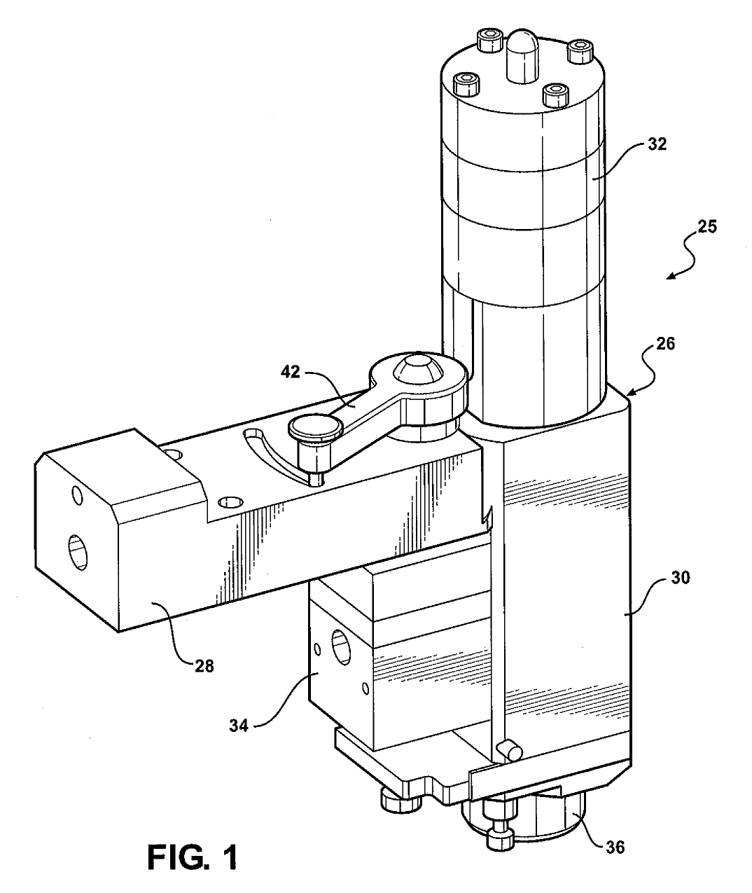

Referring to the Figures, wherein like numerals indicate like or corresponding parts throughout the several views, a filling valve assembly 25 is generally shown in FIGS. 1-3. The filling valve assembly 25 includes a valve subassembly 26 that is selectively mounted to a support 28. The valve subassembly 26 in turn includes a valve body 30 with an actuator 32 and a recirculation device 34 mounted to the valve body 30. An exit cone 36 is also releasably attached to the valve body 30. A valve stem 38 having a stem tip 40 is selectively mounted within the valve body 30 to the actuator 32.

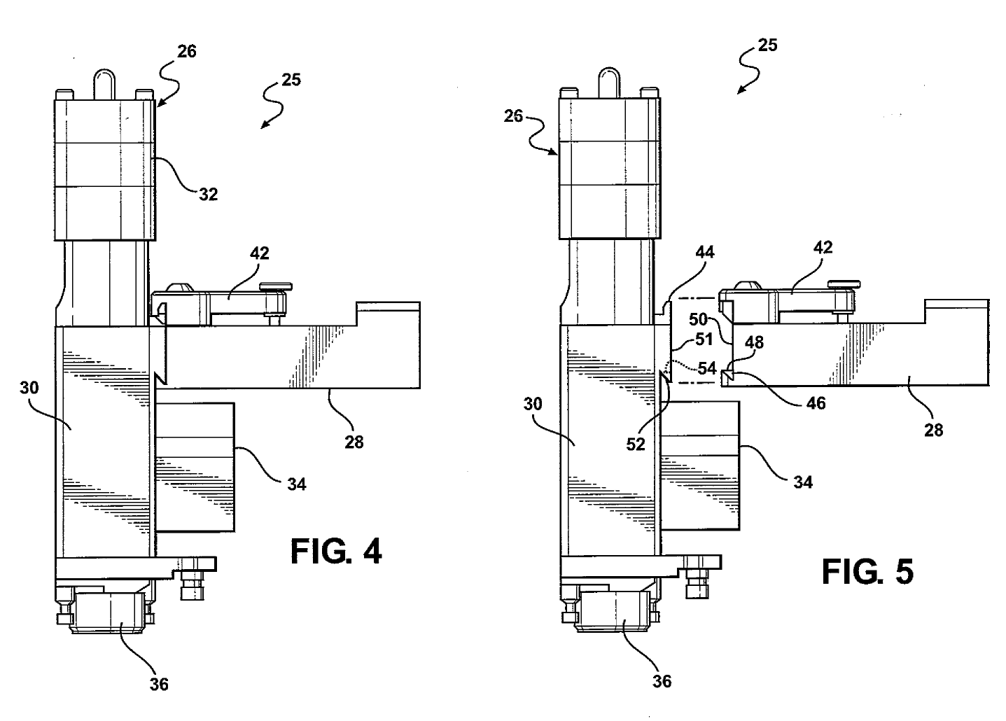

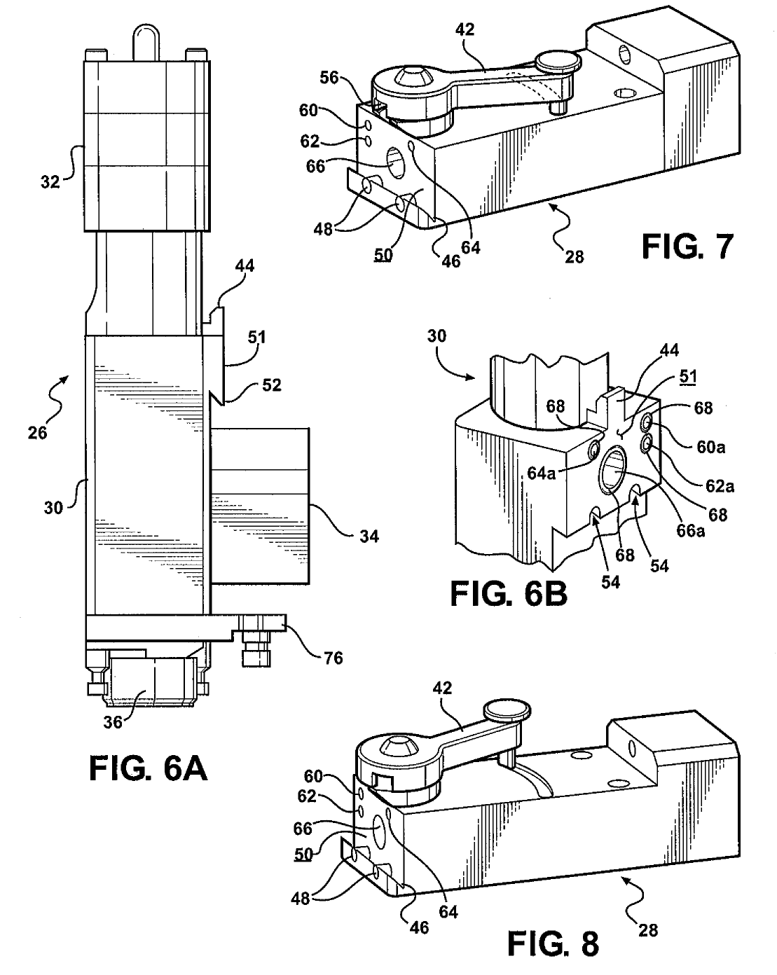

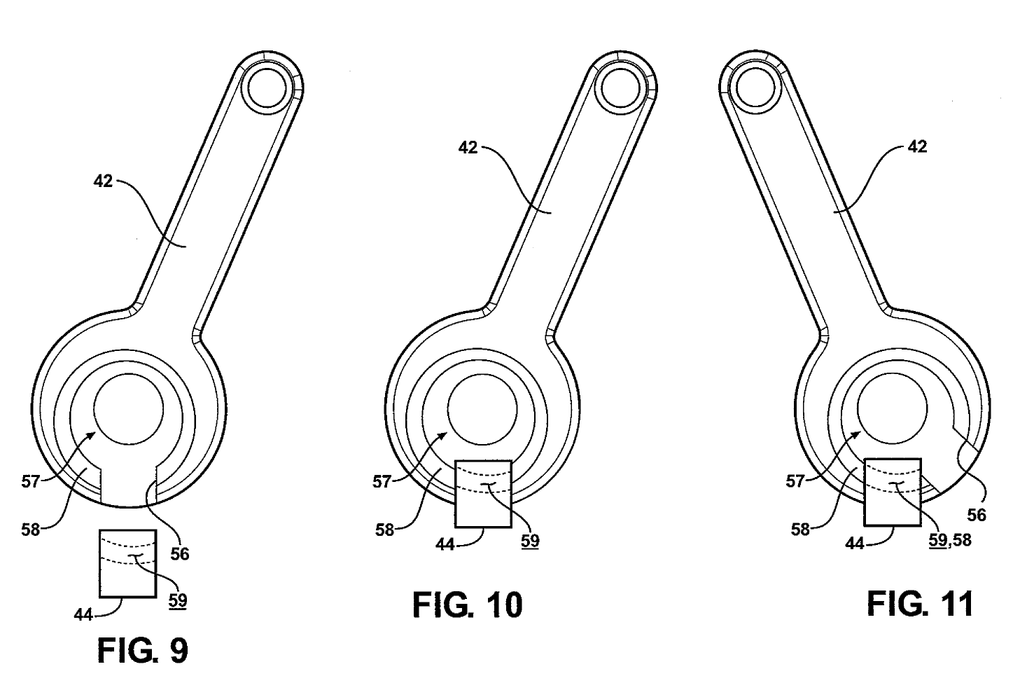

As shown in FIGS. 4-11, the valve subassembly 26 is capable of being efficiently and quickly removed from or installed onto the support 28 without the use of tools, thereby facilitating the modular interchangeability of valve subassembly 26 relative to support 28, promoting quick replacement of valve subassemblies requiring repair, minimizing production downtime.

In particular, the support 28 includes a latch 42 that engages a tab 44 on the valve body 30. As perhaps shown best in FIGS. 6-8, the support 28 includes a dovetail notch 46 with a pair of pins 48 extending transverse to the notch 46, and valve body 30 includes the tab 44 as discussed above and a lower dovetail lip 52. Referring to FIG. 6B, lower dovetail lip 52 includes a pair of slots 54 that mate with the pins 48 of the support 28. Specifically, the lower dovetail lip 52 and slots 54 of the valve body 30 engage and align with the dovetail notch 46 and pins 48 of the support 28 when the valve subassembly 26 is disposed on the support 28. Once inserted onto the notch 46 of the support 28, with slots 54 seated onto pins 48, the valve subassembly 26 is rocked toward the support 28 until interfacing surfaces 50 and 51 of support 28 and valve body 30 are brought together. Tab 44 of the valve body 30 is then engaged by the latch 42, securing the valve subassembly 26 to support 28. Thus, it can now be readily understood that the interengagement of dovetail notch 46 and dovetail lip 52 acts to relatively position interfacing surfaces 50 and 51 vertically, and the interengagement of slots 54 and pins 48 acts to relatively position interfacing surfaces 50 and 51 horizontally. It can now be further readily understood that the interengagement of latch 42 and tab 44 holds interfacing surfaces 50 and 51 in operative position, and valve subassembly 26 is attached to support 28, through the engagement of latch 42 and tab 44.

As best shown in FIGS. 7-11, the latch 42 can rotate on the support 28. The latch 42 includes an opening 56 for receiving the tab 44 of the valve body 30. The latch 42 has an arcuate interior 57 with a cam 58 having a sloped configuration. The tab 44 extends into the arcuate interior 57 of latch 42 through latch opening 56, and has an arcuate shaped engagement surface 59 for being slidably engaged by cam 58 within the arcuate interior of the latch 42 when latch 42 is moved to its locked position. Movement of the latch 42 from the unlocked position (FIGS. 7, 9 and 10) to the locked position (FIGS. 8 and 11) draws the valve body 30 into close contact with the support 28, bringing their respective interfacing surfaces 51, 50, into abutment. The arcuate shape of the engagement surface 59 on tab 44 is sloped in such a manner to cause this movement of the valve body 30 relative to the support 28. The cam 58 of latch 42 acting on surface 59 of tab 44 wedges the tab 44 between the latch 42 and support 28.

As best shown in FIGS. 7 and 8, surface 50 of the support 28 also includes the openings of fluid lines or passages 60, 62, 64, and 66 integrated into support 28. These fluid passages include air passages 60, 62, 64 and liquid passage 66, the openings of which are located in surface 50 of support 28. Specifically, the support 28 includes a first integrated operation air line 60 that is used for a short stroke of the valve stem 38 for releasing a relatively lower volume of fluid. The support 28 also includes a second integrated operation air line 62 that is used for a long stroke of the valve stem 38 for releasing a relatively higher volume of fluid. Further, the support 28 includes an integrated recirculation air line 64 for connection to the recirculation device 34. Liquid received by support 28 from the filling machine flows through liquid line 66. Respective mating openings of respectively mating integrated fluid lines 60a, 62a, 64a and 66a in the valve subassembly 26, which direct the flow of air and liquid to the appropriate locations, are located in surface 51 of valve body 30. When valve subassembly 26 is affixed to support 28, the respective pairs of fluid passage openings in surfaces 50 and 51 are aligned, thereby placing the associated fluid passages of the support 28 and the valve subassembly 26 in fluid communication.

Surface 51 of the valve body 30 also includes integrated O-rings 68 securely disposed in counter-bored annular grooves surrounding each of openings 60a, 62a, 64a, and 66a, for sealingly connecting together openings 60 and 60a, 62 and 62a, 64 and 64a, and 66 and 66a, when latch 42 is locked. That is, when the valve body 30 is mounted to the support 28, the O-rings 68 seal about the respectively mated openings of integrated fluid lines 60, 60a, 62, 62a, 64, 64a, 66 and 66a. The sealing and engagement of the O-rings 68 with abutting surface 50 of the support 28 occurs automatically as the latch 42 is moved to the locked position.

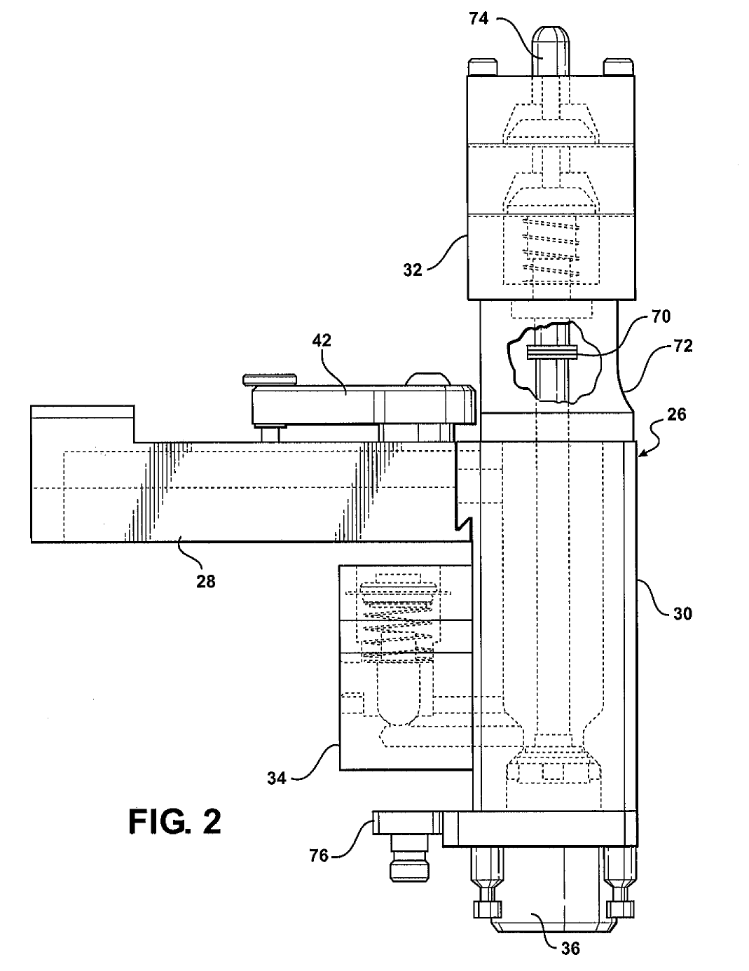

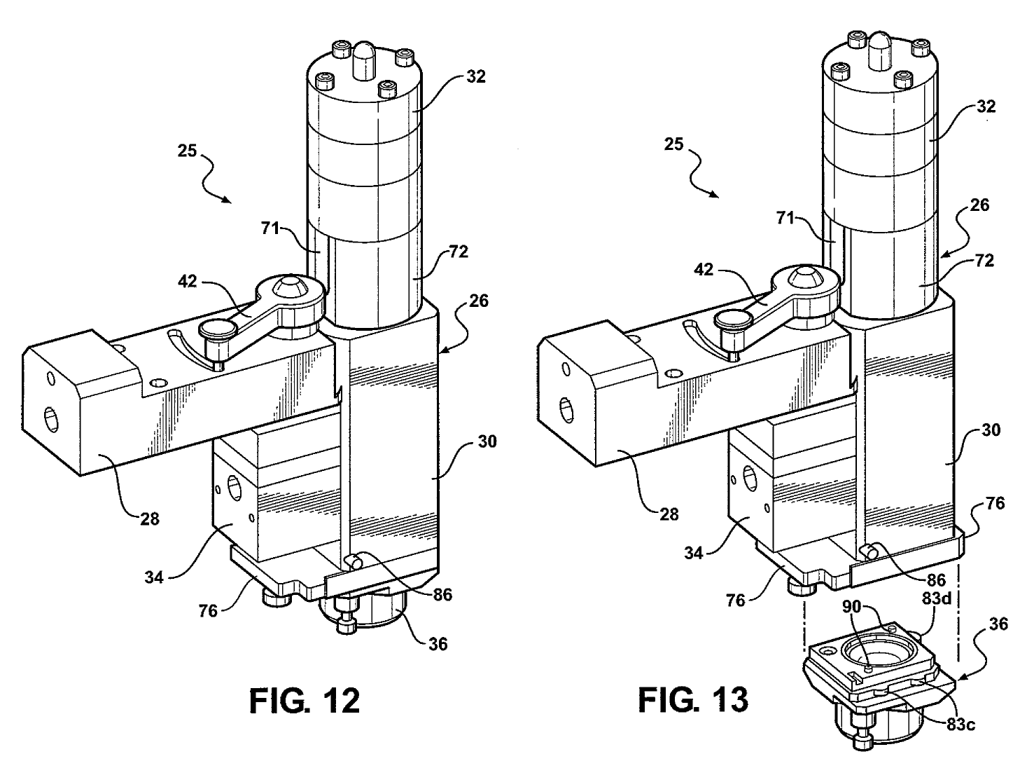

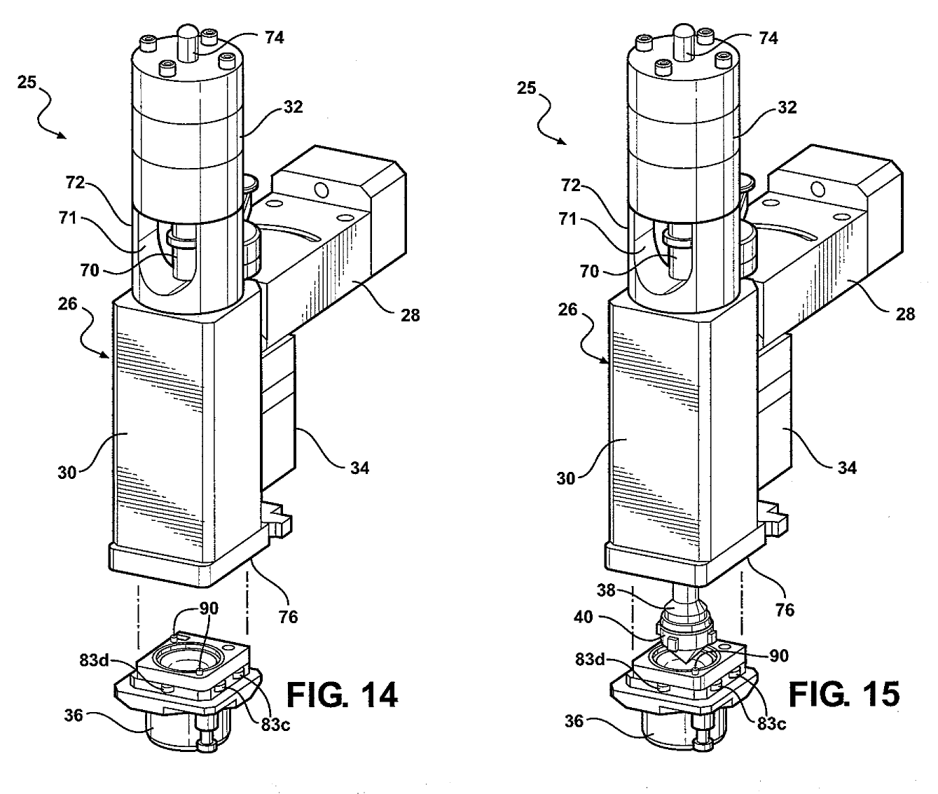

In addition to the selective attachability and detachability of the valve subassembly 26 to support 28, it is beneficial to be able to access many of the inner working components within the valve subassembly 26 for servicing. One of the items that often becomes worn is the valve stem 38. The subject invention includes a unique process to remove and replace the valve stem 38. In particular, with reference to FIGS. 12-15, the exit cone 36 is removable from the valve body 30. Once the exit cone 36 is removed, the user actuates a quick release mechanism 70 (see FIGS. 2, 14 and 15) to release the valve stem 38. The quick release mechanism 70 is accessible through an opening 71 in mount 72 of valve subassembly 26. The quick release mechanism 70 preferably includes a sliding latch as disclosed in greater detail in U.S. Patent Application Publication No. 2007/0113917, the complete disclosure of which is expressly incorporated herein by reference. Upon re-installation of the valve stem 38 into the valve body 30, inserted first or terminal end 73 of valve stem 38 will often engage an interior component of the valve body 30, which inhibits the assembler's ability to fully engage the valve stem 38 with the quick release mechanism 70. In order to ensure proper engagement, a push pin 74 is provided. The push pin 74 is coupled to the quick release mechanism 70 and extends through the actuator 32. A user actuates the push pin 74 to move the quick release mechanism 70 downward and into engagement with the terminal end 73 of valve stem 38. Once the valve stem 38 is securely installed in the valve body, the exit cone 36 can then be easily re-installed.

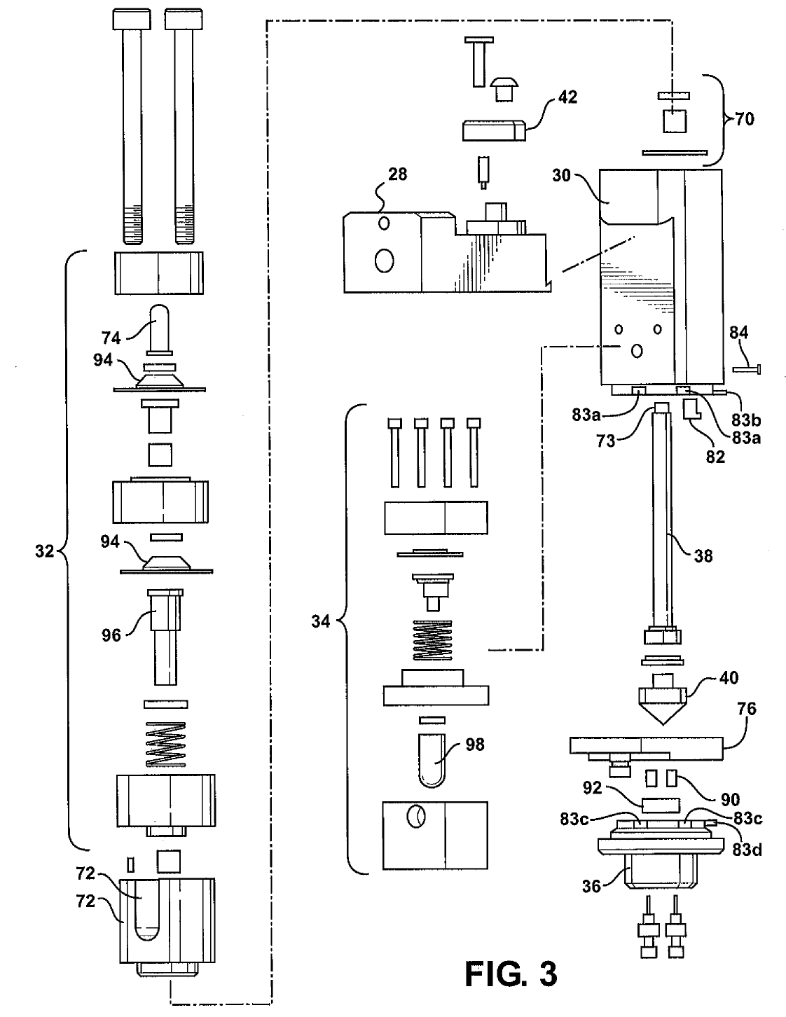

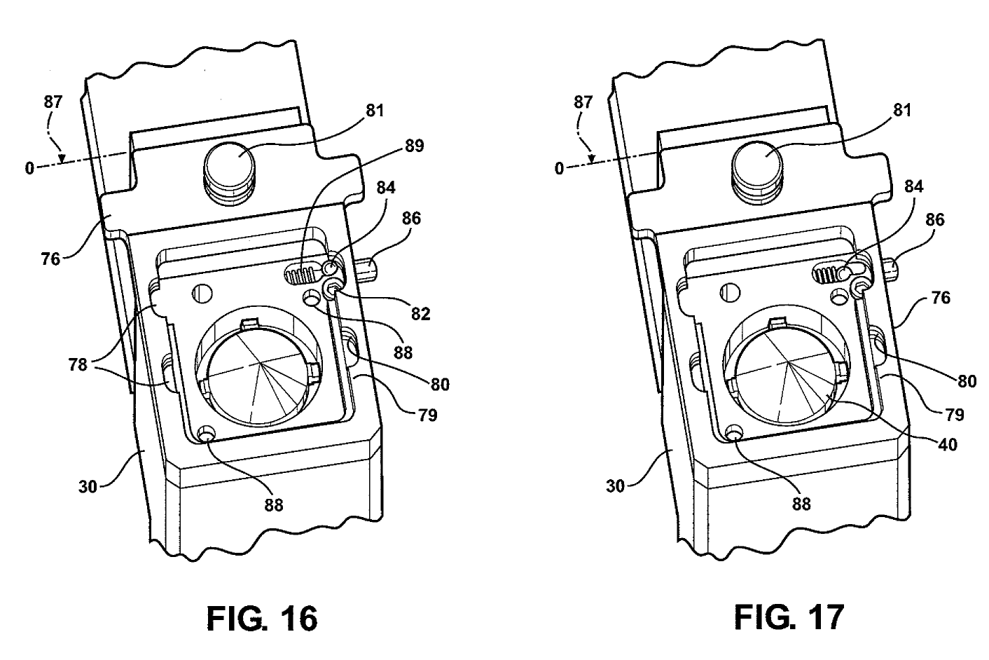

The removal and re-installation of the exit cone 36 is also done in a unique manner. Turning to FIGS. 16-19, the particulars of the removal and securing of the exit cone 36 are now discussed. The valve body 30 includes at least one and preferably a pair of holes 88 for receiving a post or posts 90 (see FIGS. 3 and 13-15) on the exit cone 36 to align the exit cone 36 with the valve body 30. To secure the exit cone 36 to the valve body 30, a rectangular, frame-like neck slide 76 is provided on an underside of the valve body 30, the exit cone being inserted into the central aperture or void defined by the frame, with exit cone posts 90 being received in valve body holes 88, to control the exit cone installed position.

As best shown in FIGS. 24A-24C, the neck slide 76 includes two pairs of aligned recesses or slots 78 on each opposite lateral side of the neck slide 76, each recess or slot being open towards and partially defining the neck slide central aperture. As shown best in FIG. 24B, each lateral side, and one end, of the neck slide 76 is substantially C-shaped in cross section, defining a first, upper flange 77 and a second, lower flange 79 with a groove 80 extending between the flanges 77, 79 and being open to the central aperture. On each lateral side of neck slide 76, each flange 77, 79 includes a pair of slots or recesses 78, with corresponding slots or recesses 78 in the flanges 77, 79 being aligned. Flanges 77, 79 and groove 80 are included in the end of the neck slide 76 opposite the end that is provided with handle 81. Handle 81 is for grasping to slide the neck slide relative to the valve body 30 between locked and unlocked positions.

Valve body 30 includes tabs 83a that, in the neck slide locked and first unlocked positions, are disposed in groove 80 and align with and overlap portions of first, upper flange 77 on the opposite lateral sides of the neck slide 76. Valve body 30 also includes a tab 83b that, in the neck slide locked and first unlocked positions, is disposed in groove 80 and aligns with and overlaps first, upper flange 77 at the end of neck slide 76. Thus, in the neck slide locked and first unlocked positions, neck slide 76 is retained to valve body 30.

As described further herein below, the neck slide second unlocked position is achieved by further sliding the neck slide 76 beyond its first unlocked position and further away from its locked position. In the neck slide second unlocked position valve body tabs 83a, which are sized substantially equal to the width of the slots or recesses 78 of the neck slide 76, become aligned with the slots or recesses 78, and valve body tab 83b is positioned such that it is clear of and no longer overlaps neck slide first, upper flange 77. Installation and removal of the neck slide 76 to and from the valve body 30 is facilitated in the neck slide second unlocked position, with tabs 83a passing through slots or recesses 78, and tab 83b passing with clearance past first, upper flange 77. Installation and removal of neck slide 76 to and from valve body 30 is respectively done prior to installation of exit cone 36 to and removal of exit cone 36 from valve body 30. That is, installation and removal of neck slide 76 to and from valve body 30 is done when exit cone 36 is not attached to the valve body 30 or the neck slide 76. Thus, the exit cone 36 may be removed and replaced, as may valve stem 38, without disassembly of the neck slide 76 from the valve body 30.

Exit cone 36 includes tabs 83c and 83d that, in the neck slide locked position, are disposed in groove 80 and align with and overlap second, lower flanges 79 on the opposite lateral sides and end of the neck slide 76. In the neck slide locked position, exit cone 36 is retained to valve body 30 through the interengagement of neck slide 76 with tabs 83a-83d.

With the neck slide 76 in its first unlocked position, exit cone 36 is inserted into, or removed from, an opening in the bottom end of the valve body 30 through the central aperture of the neck slide 76, with exit cone posts 90 being received in, or withdrawn from, valve body holes 88. In the neck slide first unlocked position, exit cone tabs 83c are aligned with the slots or recesses 78 in second, lower flange 79 of the neck slide 76, and exit cone tab 83d is clear of second, lower flange 79, permitting installation and removal of exit cone 36 to and from the valve body 30, with tabs 83c, which are sized shorter than the length of the neck slide slots or recesses 78, passing through the slots or recesses 78, and tab 83d passing with clearance past second, lower flange 79. Tabs 83c on the exit cone 36 are ramped to provide a wedging effect as they engage the second flange 79 as the neck slide 76 is moved from its first unlocked position to its locked position. In the locked position, the exit cone 36 tabs 83c and 83d are disposed in groove 80 and slidably engaged with second, lower flange 79.

Thus, the interplay between the tabs 83a, 83b on the valve body 30, the tabs 83c, 83d on the exit cone 36, the slots or recesses 78 on the neck slide 76, and the groove 80 in the neck slide 76 allow the exit cone 36 to be selectively removed from and re-secured to the valve body 30 without removing the neck slide 76. With the exit cone 36 removed, valve stem 38 may be also removed and replaced, without removing the neck slide 76 from the valve body 30, the valve stem 38 passing through the central aperture of the neck slide frame. The neck slide 76, however, can also be removed from the valve body 30 for servicing if necessary.

The particular series of operations for the neck slide 76 are now discussed in greater detail with reference to FIGS. 16-19. In particular, as shown in FIG. 16, the neck slide 76 is held into its locked position on the valve body 30 through the use of a set screw 82 and a lock pin 84. The set screw 82 and lock pin 84 abuttingly engage opposing longitudinal ends of one of the slots or recesses 78 in the first, upper flange 77 to lock the neck slide 76 into its locked position. Ordinarily, an exit cone 36 would be disposed within the central aperture of neck slide 76, but is omitted from FIG. 16 for clarity. As noted above, in the neck slide locked position, tabs 83a, 83b of valve body 30 (as wells as tabs 83c, 83d of omitted exit cone 36) are disposed in neck slide groove 80, and overlapped by portions of the respective adjacent neck slide flange 77 (and 79). The relative distance traveled between neck slide 76 and valve body 30 in moving to each of its unlocked positions from the locked position is indicated by the scale 87 shown in FIGS. 16-19, on which the neck slide locked position corresponds to indicated position “0”, the neck slide first unlocked position corresponds to indicated position “1”, and the neck slide second unlocked position corresponds to indicated position “2”.

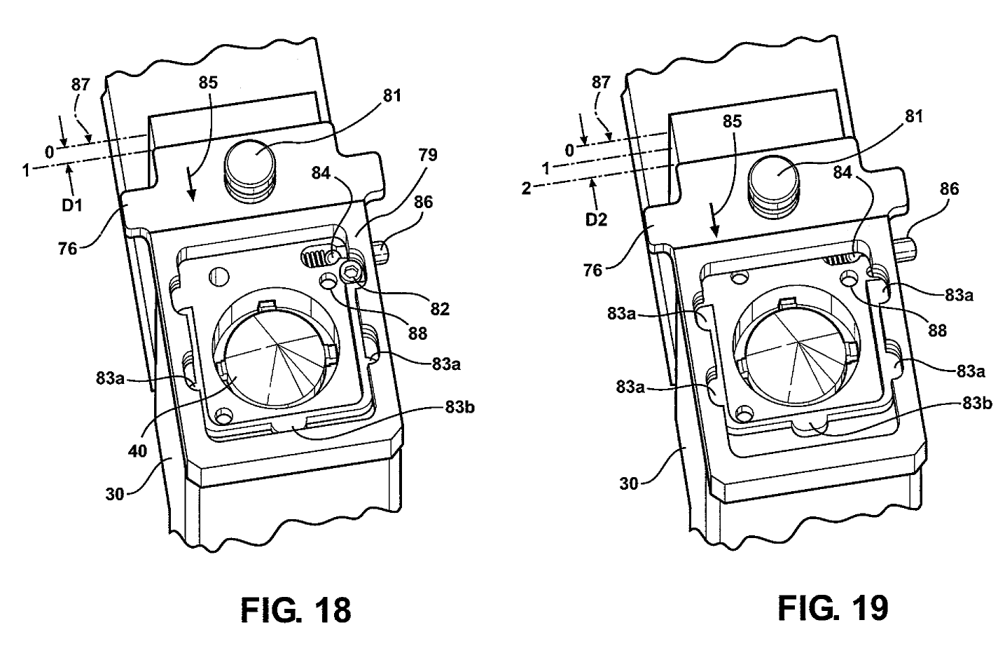

A push button 86 is in engagement with the lock pin 84 and upon actuation of the push button 86, such as shown in FIG. 17, the lock pin 84 moves out of position with in the slot or recess 78. The neck slide 76 can then slide relative to the valve body 30 to distance D1 from its locked position shown in FIG. 17, to its first unlocked position, by moving neck slide 76 in the direction of arrow 85 to the first unlocked position, as shown in FIG. 18. As noted above, the tabs 83c, 83d on the exit cone 36 are orientated and sized such that tabs 83c can pass through the slots 78 in second, lower flange 79, and tab 83d can pass with clearance past flange 79 at the end of neck slide 76, as exit cone posts 90 are received in and withdrawn from holes 88 in the valve body 30 during installation and removal of the exit cone 36. This alignment and positioning of the exit cone 36 can only be accomplished when the neck slide 76 is in the first unlocked position shown in FIG. 18. The neck slide 76 does not detach from the valve body 30 when in the first unlocked position shown in FIG. 18, as the tabs 83a on the valve body 30 are larger than tabs 83c and are not fully aligned with the slots 78. Moreover, in the first unlocked position, valve body tab 83b is still disposed in groove 80 and partially engaged with first, upper flange 77 at the end of neck slide 76.

The set screw 82 is secured to the valve body 30 within one of slots or recesses 78 in first, upper flange 77, and prevents the neck slide 76 from sliding past its first unlocked position shown in FIG. 18 by its head abutting on the edge of flange 77 defining an end of that recess 78 in which set screw 82 is disposed. After the exit cone 36 is placed into position, the neck slide 76 can be slid back into its locked position in which tabs 83c, 83d become disposed in groove 80 and engage second, lower flange 79. As the neck slide 76 moves back to the original, locked position, the lock pin 84 automatically re-engages the slot or recess 78 to re-secure the neck slide 76 in the locked position shown in FIG. 16. The lock pin 84 is continuously biased against the interior edge of flange 77, as by spring 89 which tends to move lock pin 84 into the recess 78 once the neck slide it returned to the locked position.

With reference now to FIG. 19, with the removal of set screw 82, the neck slide 76 can be further slid relative to the valve body 30 in the direction of arrow 85 to a distance D2 from its locked position by moving neck slide 76 to its second unlocked position, as shown in FIG. 19. As noted above, the neck slide 76 is removed from or installed onto the valve body 30 in the second unlocked position, with exit cone 36 removed from the assembly. In the second unlocked position, tabs 83a on the valve body are positioned to pass through the slots 78 in first, upper flange 77, and tab 83b is positioned to pass with clearance past flange 77 at the end of neck slide 76, during installation and removal of the neck slide 76 relative to the valve body 30. The installation and removal of the neck slide from the valve body can only be accomplished when the neck slide 76 is in the second unlocked position shown in FIG. 19. After re-installation of the neck slide, the set screw 82 is re-installed with the neck slide positioned at its first unlocked position, and exit cone 36 is then re-installed. The neck slide 76 can then be slid back into its locked position, with lock pin 84 automatically re-engaging the slot or recess 78 to re-secure the neck slide 76 in the locked position.

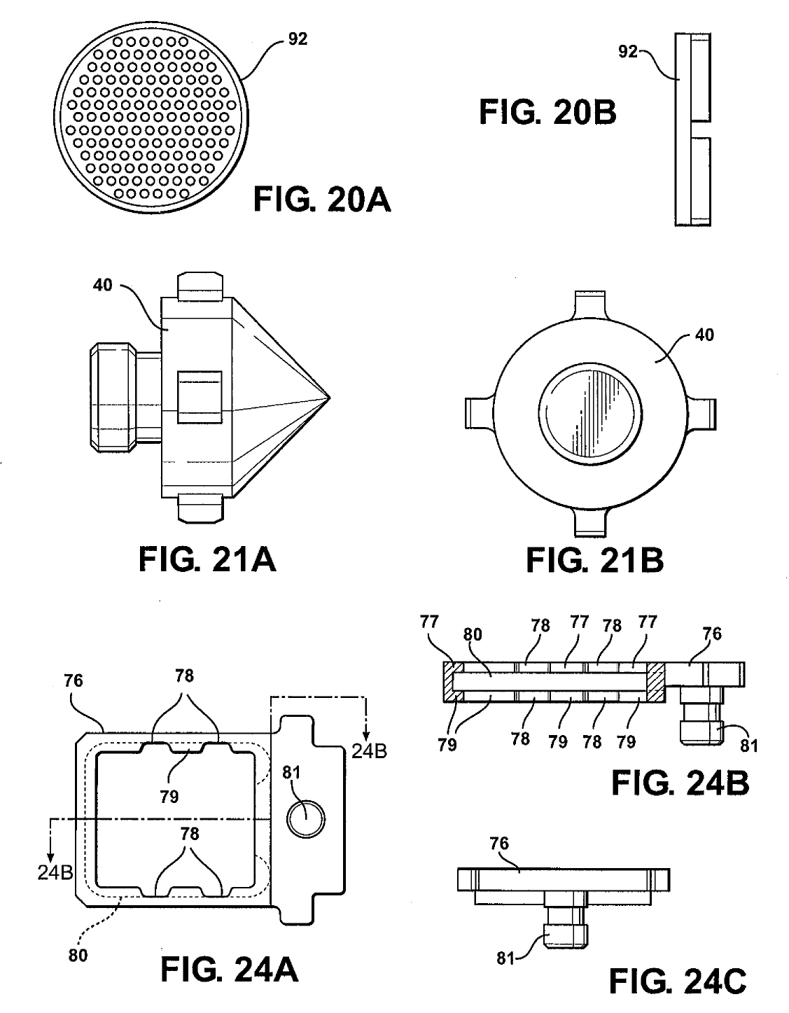

As shown in FIGS. 20A-20B, one or more tension plugs 92 can be locked into the exit cone 36. In particular, the tension plug is preferably formed of a polymeric material and includes a unique configuration for snap fitting into a groove within the exit cone 36.

FIGS. 21A-21B disclose further detail of the configuration of the stem tip 40 disposed at the second end of the valve stem 38. This particular configuration of the valve stem 38 seals an interior chamber of the valve body 30 in an up position.

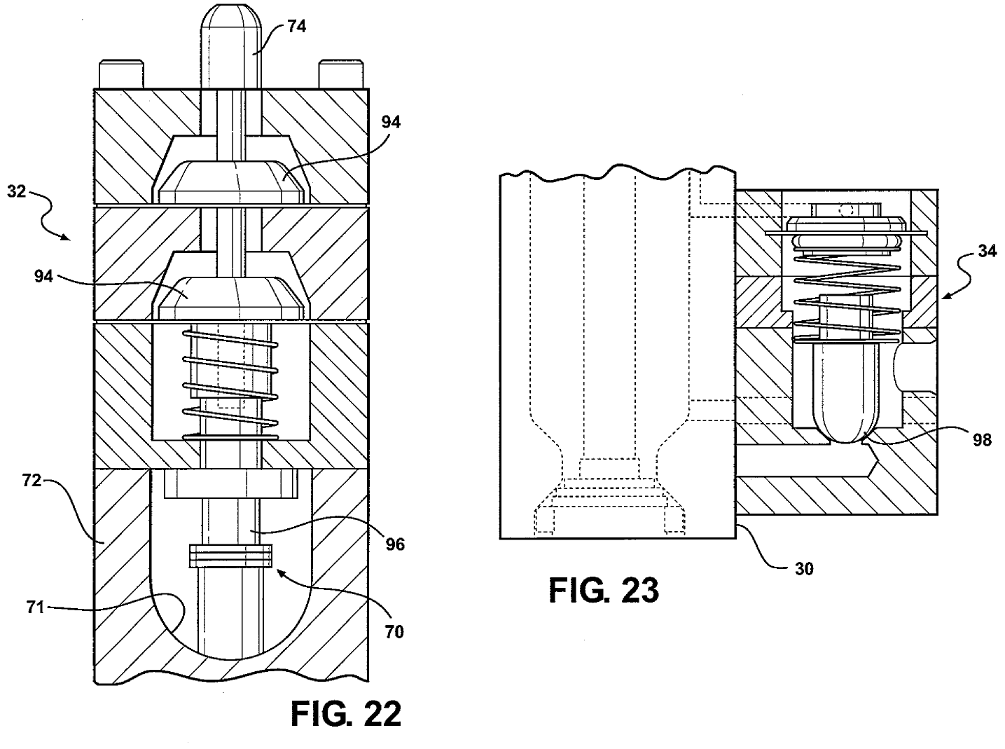

FIG. 22 discloses a transparent view of the actuator 32. The actuator 32 includes a number of components for actuating the valve stem 38 to release or seal the discharge of fluid. This particular embodiment of the actuator 32 includes two different operational strokes such that the actuator 32 includes a pair of independently operable diaphragms 94. A spindle 96 is provided within the actuator 32 for providing the requisite movement to the valve stem 38. The spindle 96 includes a portion of the quick release mechanism 70.

Turning to FIG. 23, the recirculation device 34 is shown in greater detail. The recirculation device 34 includes a spring-biased plunger 98 for releasing or restricting the flow of fluid. Although not required, the filling valve assembly disclosed in the Figures is designed to continuously recirculate fluid even when fluid is not being discharged out of the exit cone 36. Recirculating filling valves of various types have been previously used in the industry in a number of applications include the filling of fluids at elevated temperatures.

The invention has been described in an illustrative manner, and it is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise than as specifically described.

What is claimed is:

1. A filling valve assembly comprising:
a support adapted for being operably fixed to a filling machine and through which liquid is conveyed from the filling machine; and
a valve subassembly interchangeably attached to said support, the valve subassembly and support having integrated fluid passages in fluid communication when said valve subassembly is attached to said support, at least a portion of the liquid received by said support from the filling machine being conveyed to said valve subassembly, at least a portion of the liquid received by said valve subassembly from said support being selectively dispensed from said valve subassembly;
wherein said fluid passages of said support and said valve subassembly are connected through fluid openings located in respective interfacing surfaces of said valve subassembly and said support, when said valve subassembly is attached to said support.

2. The filling valve assembly of claim 1, wherein said respective interfacing surfaces are in abutting contact, said fluid openings located in said surfaces being aligned.

3. The filling valve assembly of claim 2, wherein said interfacing surfaces contain a plurality of pairs of aligned fluid openings, a fluid passage in said support being in fluid communication with a fluid passage in said valve subassembly through each pair of said aligned fluid openings, liquid from the filling machine being conveyed to said valve subassembly through one pair of said plurality of pairs of aligned fluid openings.

4. The filling valve assembly of claim 3, wherein air is conveyed between said support and said valve assembly through at least one other pair of said plurality of pairs of aligned fluid openings.

5. The filling valve assembly of claim 2, wherein one of said interfacing surfaces includes an annular counterbore surrounding each said fluid opening therein, an o-ring being disposed in each said counterbore, said o-ring sealingly engaging the other of said interfacing surfaces when said valve subassembly is attached to said support, whereby a sealed connection is provided for each pair of said plurality of pairs of aligned fluid openings.

6. The filling valve assembly of claim 2, wherein said interfacing surfaces of said valve subassembly and said support are substantially planar.

7. The filling valve assembly of claim 1, wherein said valve subassembly and said support have respectively interengagable features through the interengagement of which their said interfacing surfaces are positioned relative to each other.

8. The filling valve assembly of claim 7, wherein said respectively interengageable features comprise a lip provided on one of said valve subassembly and said support, and a notch into which said lip is received provided on the other of said valve subassembly and said support.

9. The filling valve assembly of claim 8, wherein said notch is a dovetail notch and said lip is a dovetail lip.

10. The filling valve assembly of claim 7, wherein said respectively interengageable features further comprise at least one pin provided on one of said valve subassembly and said support, and a slot into which said at least one pin is received provided on the other of said valve subassembly and said support.

11. The filling valve assembly of claim 8, wherein said notch is provided with one of at least one pin and a slot into which said pin is received, and said lip is provided with the other of said at least one pin and said slot into which said pin is received.

12. The filling valve assembly of claim 11, wherein said respectively interengageable features further comprise a tab provided on one of said valve subassembly and said support, and a latch provided on the other of said valve subassembly and said support, said tab being selectively engaged by said latch, said interfacing surfaces being held in operative position, and said valve subassembly being attached to said support, through the engagement of said latch and said tab.

13. The filling valve assembly of claim 7, wherein said respectively interengageable features comprise a tab provided on one of said valve subassembly and said support, and a latch provided on the other of said valve subassembly and said support, said tab being selectively engaged by said latch, said interfacing surfaces being held in operative position, and said valve subassembly being attached to said support, through the interengagement of said latch and said tab.

14. The filling valve assembly of claim 1, wherein said filling valve assembly is a recirculating filling valve assembly through which liquid is continually received by said valve subassembly from said support, liquid received by said valve subassembly from said support and not dispensed from said valve subassembly being returned to the filling machine.

15. A filling valve assembly comprising:
a support fixed to a filling machine; and
a valve subassembly selectively mounted to said support, at least a portion of the liquid received by said valve subassembly from said filling machine being selectively dispensed from said valve subassembly when said valve subassembly is mounted to said support and in fluid communication with the filling machine;
said valve subassembly and said support having respectively interengagable features through the interengagement of which said valve subassembly is mounted to said support;
said respectively interengageable features comprising a notch provided on one of said valve subassembly and said support, and a lip into which said notch is received when said valve subassembly is mounted to said support provided on the other of said valve subassembly and said support;
said respectively interengageable features further comprising a tab provided on one of said valve subassembly and said support, and a latch provided on the other of said valve subassembly and said support, said tab and said latch being selectively interengaged when said lip is received in said notch, said valve subassembly being mounted to said support through the interengagement of said latch and said tab.

16. The filling valve assembly of claim 15, wherein said notch is a dovetail notch and said lip is a dovetail lip.

17. The filling valve assembly of claim 15, wherein said respectively interengageable features further comprise at least one pin provided on one of said valve subassembly and said support, and a slot into which said at least one pin is received provided on the other of said valve subassembly and said support, the relative positioning of said valve subassembly and said support being limited by the interengagement of said pin and said slot as said valve subassembly is being mounted to said support.

18. The filling valve assembly of claim 17, wherein said notch is provided with one of said at least one pin and said slot into which said pin is received, and said lip is provided with the other of said at least one pin and said slot into which said pin is received.

19. The filling valve assembly of claim 15, wherein said tab is received into an opening in said latch, said tab and said latch having respective engagement surfaces being selectively engaged after said tab is received into said latch opening whereby said valve subassembly is mounted to said support.

20. The filling valve assembly of claim 19, wherein said tab and latch engagement surfaces are selectively slidably engaged.

21. The filling valve assembly of claim 20, wherein at least one of said tab and latch engagement surfaces is a cam, sliding engagement between said tab and latch engagement surfaces drawing said valve subassembly and said support together as said valve subassembly is being mounted to said support.

22. The filling valve assembly of claim 21, wherein said tab is provided on said valve subassembly and said latch is provided on said support, said tab being wedged between said latch and said support during sliding engagement between said tab and latch engagement surfaces as said valve subassembly is being mounted to said support.

23. The filling valve assembly of claim 15, wherein said latch is rotatable between an unlatched position in which said latch and said tab are not interengaged, and a latched position in which said latch and said tab are interengaged when said valve subassembly is mounted to said support.

24. The filling valve assembly of claim 15, wherein said support and said valve subassembly include integral fluid passages that are in fluid communication when said valve subassembly is mounted to said support, liquid received by said valve subassembly from the filling machine being conveyed through said integral fluid passages.

25. The filling valve assembly of claim 24, wherein said valve subassembly and said support include respectively interfacing surfaces that are brought into abutting contact as said valve subassembly is being mounted to said support, said valve subassembly interfacing surface including an opening to said valve subassembly integral fluid passage, said support interfacing surface including an opening to said support integral fluid passage, said openings being aligned and sealably connected when said valve subassembly is mounted to said support.

26. The filling valve assembly of claim 25, wherein said interfacing surfaces contain a plurality of pairs of aligned fluid openings, a respective fluid passage in said support being in fluid communication with a respective fluid passage in said valve subassembly when said valve subassembly is mounted to said support through each pair of said aligned fluid openings, liquid from the filling machine being conveyed to said valve subassembly through one pair of said plurality of pairs of aligned fluid openings.

27. The filling valve assembly of claim 26, wherein air is conveyed between said support and said valve subassembly through at least one other pair of said plurality of pairs of aligned fluid openings.

28. The filling valve assembly of claim 26, wherein one of said interfacing surfaces includes an annular counterbore surrounding each said fluid opening therein, an o-ring being disposed in each said counterbore, said o-ring sealingly engaging the other of said interfacing surfaces when said valve subassembly is mounted to said support, whereby a sealed connection is provided for each pair of said plurality of pairs of aligned fluid openings.

29. The filling valve assembly of claim 26, wherein said interfacing surfaces of said valve subassembly and said support are substantially planar.

30. The filling valve assembly of claim 24, wherein said filling valve assembly is a recirculating filling valve assembly through which liquid is continually received by said valve subassembly from said support when said valve subassembly is mounted to said support, liquid received by said valve subassembly from said support and not dispensed from said valve subassembly being returned to the filling machine.

31. A filling valve assembly comprising:
a valve body having an end and an opening at said valve body end;
an elongate valve stem disposed within said valve body, said valve stem having a first end and an opposite second end, said valve stem being installed into and removed from said valve body through said valve body opening, said valve stem being longitudinally movable within said valve body along a central axis, the flow of a liquid received in said valve body, from said valve body through said valve body opening, being controlled in response to longitudinal movement of said valve stem;
a neck slide disposed at said valve body end and being laterally movable relative to the central axis, said neck slide having selective locked and first unlocked positions, said neck slide and said valve body having respectively interengaging features through which said neck slide is retained to said valve body in said neck slide locked and first unlocked positions; and
a removable exit cone disposed at said valve body end, said exit cone covering said valve body opening, with liquid flow from said valve body through said valve body opening being through said exit cone, said neck slide and said exit cone having respectively interengaging features through which said exit cone is retained to said valve body and said neck slide in said neck slide locked position, and said exit cone is separable from said valve body and neck slide in said neck slide first unlocked position.

32. The filling valve assembly of claim 31, wherein said neck slide has a central void through which said valve stem is inserted into or removed from the valve body opening with said exit cone removed from said filling valve assembly.

33. The filling valve assembly of claim 32, wherein said neck slide forms a substantially rectangular frame-like structure having a central aperture through which said valve stem is inserted into or removed from the valve body opening with said exit cone removed from said filling valve assembly.

34. The filling valve assembly of claim 32, wherein said removable exit cone, when installed, is disposed in said neck slide central void.

35. The filling valve assembly of claim 31, wherein said exit cone is provided with one of at least one post and a hole into which said post is received, and said valve body is provided with the other of said at least one post and said hole, the installed position of said exit cone relative to said valve body being controlled by the interengagement of said post and said hole.

36. The filling valve assembly of claim 31, wherein said neck slide and said exit cone respectively interengaging features comprise:
one of said exit cone and said neck slide having a flange extending laterally relative to the central axis, said flange having an edge in which is formed a recess; and
the other of said exit cone and said neck slide having at least one tab extending laterally relative to the central axis;
said flange and said tab having an overlapping relationship and being engaged in said neck slide locked position, said recess and said tab being aligned in said neck slide first unlocked position wherein said tab and said flange are not in overlapping relationship and said tab may be passed through said recess, whereby said exit cone may be removed from and installed onto said valve body in said neck slide first unlocked position.

37. The filling valve assembly of claim 31, wherein said neck slide and said valve body respectively interengaging features comprise:
one of said neck slide and said valve body having a flange extending laterally relative to the central axis; and
the other of said neck slide and said valve body having at least one tab extending laterally relative to the central axis;
said flange and said tab having an overlapping relationship and being engaged in and between said neck slide locked and first unlocked positions.

38. The filling valve assembly of claim 37, wherein said neck slide has a selective second unlocked position, said neck slide being separable from said valve body in said neck slide second unlocked position, and wherein said flange has an edge in which is formed a recess; said recess and said tab being aligned in said neck slide second unlocked position wherein said tab and said flange are not in overlapping relationship and said tab may be passed through said recess, whereby said neck slide may be removed from and installed onto said valve body in said neck slide second unlocked position.

39. The filling valve assembly of claim 31, wherein said neck slide has a selective second unlocked position, said neck slide being separable from said valve body in said neck slide second unlocked position; and wherein
said neck slide and said valve body respectively interengaging features comprise:
said neck slide having a pair of opposed first, upper flanges slidably engaging said valve body and extending laterally relative to the central axis;
said valve body having at least one pair of opposed tabs extending laterally outward relative to the central axis;
said first, upper flanges and said pair of opposed valve body tabs having an overlapping relationship and being engaged in and between said neck slide locked and first unlocked positions;
wherein said pair of first, upper flanges have laterally inner edges in which are formed a pair of opposed first recesses, each said first recess and a said valve body tab being aligned in said neck slide second unlocked position wherein said valve body tabs and said first, upper flanges are not in an overlapping relationship and said valve body tabs may be passed through said first recesses, whereby said neck slide may be removed from and installed onto said valve body in said neck slide second unlocked position; and wherein
said neck slide and said exit cone respectively interengaging features comprise:
said neck slide having a pair of opposed second, lower flanges separated along the central axis from substantially parallel with said first, upper flanges;
said exit cone having at least one pair of opposed tabs extending laterally outward relative to the central axis;
said second, lower flanges and said pair of opposed exit cone tabs having an overlapping relationship and being engaged in said neck slide locked position;
wherein said pair of second, lower flanges have laterally inner edges in which are formed a pair of opposed second recesses, each said second recess and a said exit cone tab being aligned in said neck slide first unlocked position wherein said exit cone tabs and said second, lower flanges are not in an overlapping relationship and said exit cone tabs may be passed through said second recesses, whereby said exit cone may be removed from and installed onto said valve body in said neck slide first unlocked position.

40. The filling valve assembly of claim 39, further comprising a lock pin resiliently biased into a locking position in one of said first recesses, and a removable fastener secured to said valve body, a portion of said fastener being disposed in said one of said first recesses, said lock pin and said fastener portion being respectively located at and in abutting contact with longitudinally opposite first and second ends of said one of said first recesses in said neck slide locked position, movement of said neck slide from its locked position being prevented by abutment of said lock pin and said first recess end; and wherein
said neck slide is moveable from its locked position to its first unlocked position when said lock pin moved out of said recess against said biasing force, further movement of said neck slide from its first unlocked position to its second unlocked position being prevented by abutment of said fastener portion and said first recess end; and wherein
said neck slide is moveable from its first unlocked position to its second unlocked position when said fastener is removed from said valve body.

41. The filling valve assembly of claim 31, wherein said filling valve assembly is a recirculating filling valve assembly into which liquid is continually received from a source of liquid, liquid received by said valve assembly body and not flowing through said valve body opening being returned to the source of liquid.
